(19) United States
(12) Patent Application Publication
(10) Pub. No.: US 2012/0076128 A1
(43) Pub. Date: Mar. 29, 2012

(54) SYSTEM AND METHOD FOR ANONYMOUS WEB CALLING CHARGING ADVICE

(75) Inventors: Yigang Cai, Naperville, IL (US); Suzann Hua, Lisle, IL (US)

(73) Assignee: ALCATEL-LUCENT USA INC., Murray Hill, NJ (US)

(21) Appl. No.: 12/890,167

(22) Filed: Sep. 24, 2010

(51) Int. Cl. H04L 12/66

(52) U.S. Cl. 370/352

(57) ABSTRACT

Methods and systems are presented for anonymous web call processing, in which an application web server prompts a calling party to initiate a web call, queries a charging server for a tariff rate associated with the anonymous web call to the specified called party, renders the tariff rate to the calling party, and prompts the calling party to confirm initiation of the anonymous web call to the specified called party.

### FIELD OF THE INVENTION

This invention relates generally to the field of networked communications, and more particularly to methods and systems for providing charging advice for anonymous web calling.

### BACKGROUND OF THE INVENTION

Web servers and the web sites implemented thereon increasingly support anonymous click-to-dial service. For instance, a caller may visit a webpage belonging to another person on a social networking or dating website and the website provides an option to make an anonymous call to the page owner. The website initiates the call to a user equipment (UE) number associated with the web site by the called party, with the call being paid for by the caller. However when the terminating party is a wireless UE that is not local to the web server or to the calling party, the cost for such click-to-dial can be high. This can happen when a web portal application needs to connect to a telecommunication networks to reach the terminating party whose UE is not able to access the internet directly for a web call, particularly when the called party UE is currently roaming in a foreign country. Thus, there is a need for new mechanism and techniques to control costs for anonymous web calls.

### SUMMARY OF THE INVENTION

The following is a summary of one or more aspects of the invention to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The various aspects of the present disclosure relate to systems and methods to mitigate callers being charged unexpected high costs for web calls. A system and method are proposed to implement a Charging Advice for Anonymous Web Calling (CA-AWC) service to alert a prospective anonymous web caller to expected costs for initiating an anonymous web call. The disclosure addresses an unmet need, where no Advice of Charging (AoC) service currently exists for Anonymous Web Calling to UE in telecommunication networks. The service can be implemented in an application web server (AWS) of a service provider network or of an Application Enabler (AE) or Application Exposure Suite (AES) used by the service provider, where the web portal application can interface with the AE to implement an anonymous web call to a UE in a telecommunication network, and where the AE provides an AoC service to web anonymous calls.

An application web server (AWS) is provided, which includes a processor programmed to prompt a calling party to initiate an anonymous web call to a specified called party via a web application. The AWS receives a selection indication from the calling party to initiate the web call and queries a charging server for a tariff rate associated with the anonymous web call to the called party. The charging server returns the tariff to the AWS, which then renders the tariff rate to the calling party and prompts the prospective caller to confirm or refuse initiation of the call. If the caller agrees to the charge rate, the AWS processor receives a confirmation from the caller via the web application and connects the anonymous web call.

In certain embodiments, the AWS aborts the anonymous call if a negative response is received after prompting the calling party to confirm initiation of the anonymous web call.

In certain embodiments, the AWS sends a SIP INVITE message to the called party UE that is registered to the web application and receives a SIP 200 OK message, and uses this to construct a query message to be sent to the charging server based at least partially on the SIP 200 OK message.

In certain embodiments, the AWS registers the calling party and obtains a phone number for the caller's UE, along with a web name, and the AWS uses this web name in connecting the anonymous web call. In certain embodiments, the AWS obtains a prepaid or postpaid account established by the calling party with a service provider associated with the web application, and/or obtains a credit card account number from the caller, and charges the prepaid or postpaid account or credit card according to the tariff rate after the anonymous web call is completed.

A method is provided for processing anonymous web calls, which includes prompting a calling party to initiate an anonymous web call to a specified called party via a web application, receiving a selection indication from the calling party indicating a desire to initiate the anonymous web call to the specified called party, and querying a charging server for a tariff rate associated with the anonymous web call to the called party. The method further involves receiving the tariff rate associated with the anonymous web call to the called party from the charging server, rendering the tariff rate to the calling party and prompting the calling party to confirm initiation of the anonymous web call to the specified called party via the web application, receiving a confirmation of the anonymous web call from the calling party via the web application, and connecting the anonymous web call.

Certain embodiments of the method also include sending a SIP INVITE message to a called party user equipment registered to the web application, receiving a SIP 200 OK message, and constructing a query message based at least partially on the SIP 200 OK message.

In certain embodiments, the method further includes receiving negative response from the calling party regarding the anonymous web call via the web application, and aborting the anonymous web call.

Certain embodiments of the method also include registering the calling party with the application web server including obtaining a phone number for user equipment of the calling party and a web name to be used in anonymous web calls initiated by the calling party, and using the web name in connecting the anonymous web call.

In certain embodiments, the method also includes obtaining a prepaid or postpaid account or a credit card account number from the caller, and charging the prepaid or postpaid account or credit card according to the tariff rate after the anonymous web call is completed.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings, in which:

FIG. 1 is a system diagram illustrating an exemplary network environment in which one or more aspects of the disclosure may be implemented;

FIG. 2 is a signal flow diagram illustrating exemplary anonymous web call processing using a charging advice for anonymous web calling (CA-AWC) service in accordance with the disclosure; and

FIG. 3 is a flow diagram illustrating an exemplary web call process in accordance with the disclosure.

### DETAILED DESCRIPTION

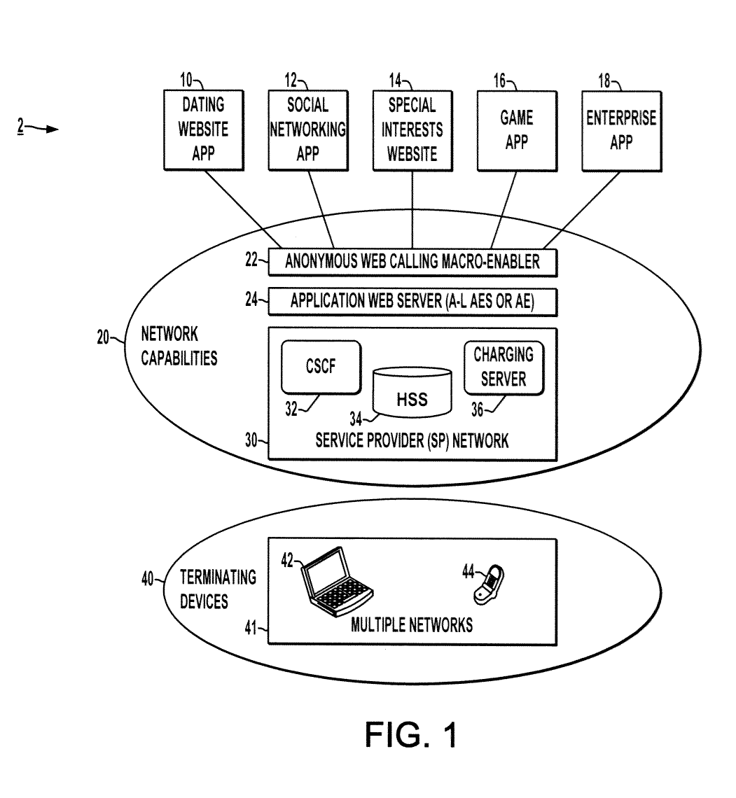

Several embodiments or implementations of the various aspects of the present disclosure are hereinafter illustrated and described in conjunction with the drawings, wherein like reference numerals are used to refer to like elements. FIG. 1 illustrates a network system 2 including a variety of web applications 10, 12, 14, 16, and 18 running on one or more processor and memory-enabled application web servers 24, with an anonymous web calling macro-enabler 22 operative in certain embodiments to facilitate anonymous web calling features of the applications 10, 12, 14, 16, and 18 to provide a Charging Advice for Anonymous Web Calling (CA-AWC) service. The web calling feature and/or the charging advice features thereof can be implemented in a single application web server (AWS), alone or along with one or more of the applications 10, 12, 14, 16, and 18, and certain of the CA-AWC and/or the web calling functions can be implemented on an AWS brokered by an Application Enabler (AE) or Application Exposure Suite (AES) used by a service provider which otherwise implements the applications 10, 12, 14, 16, and 18. An AES platform, such as offered by Alcatel-Lucent allows operators to make features on their networks available to developers and content providers in a secure manner, where the operators (e.g., service provider network operators) can run AES in their own network system or as a cloud service. Only a few applications are shown for illustrative purposes, including a dating website application 10, a social networking website application 12, a special interests website 14, an on-line game website application 16, and an enterprise application 18. These applications in certain embodiments are operated by a service provider having a service provider (SP) network 30 with a variety of network capabilities 20, including without limitation a Call Session Control Function (CSCF) 32 providing signaling and control within an IP Multimedia Subsystem (IMS) framework, a home subscriber service (HSS) 34, and a charging server 36, and the network system 2 can include various other elements normally associated with an IMS network, telecommunication networks, and the Internet. The elements of the system 2 can be implemented in any suitable form of hardware, processor-executed software, firmware, logic, or combinations thereof, and may be constructed as single components such as a servers, etc., or may be implemented in distributed fashion across two or more components operatively associated with the network 2.

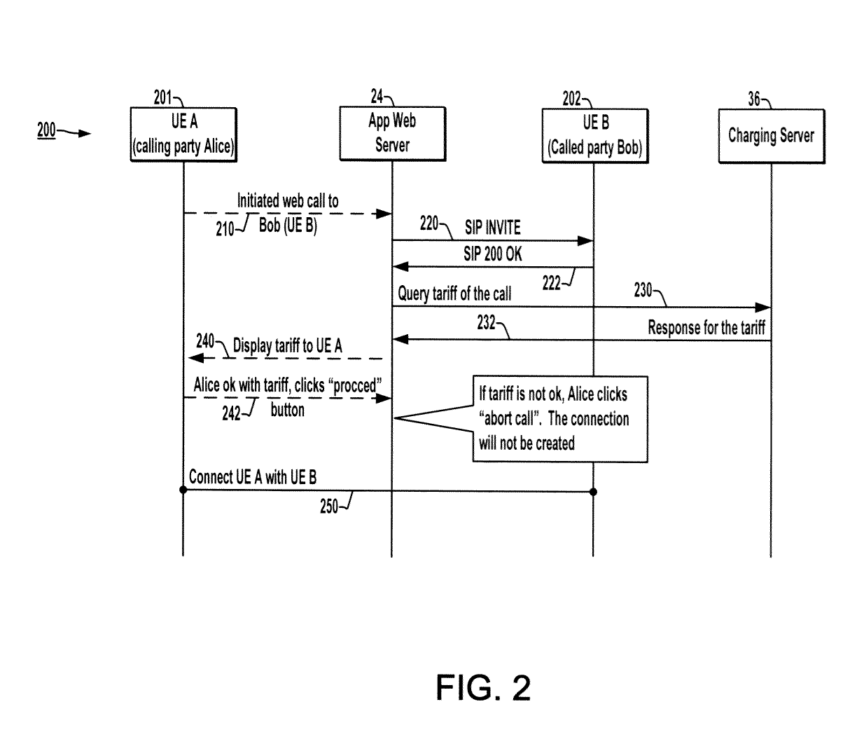

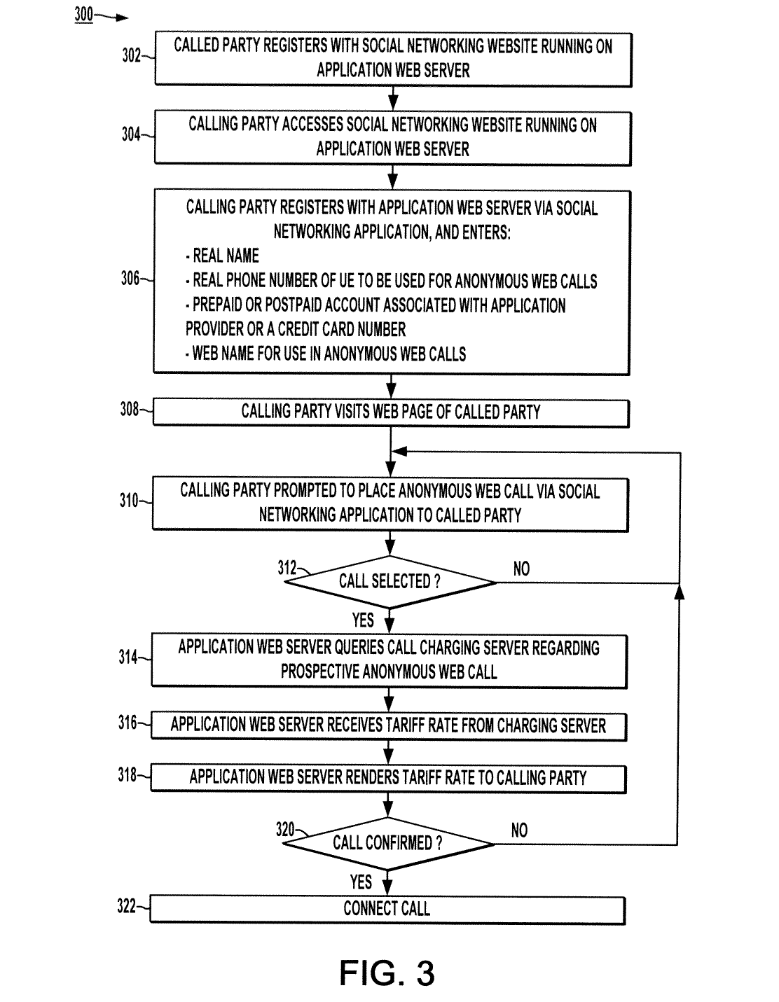

Referring also to FIGS. 2 and 3, in operation, an end user (caller or calling party) can initiate an anonymous web call via click-to-dial features of one or more of the applications 10-18 running on the AWS 24. Prior to the AWS 24 connecting the calling and called parties, the AWS 24 checks the tariff rate for the proposed call (optionally via the Application Enabler (AE)) using a query to the charging server 36, which may itself be located within AE/AES or elsewhere in the network system 2, and allows the application web server 24 to prompt a window and display the tariff rate of the proposed call to the end user (the calling party). If the tariff rate for the call is acceptable to the prospective caller, the user can select a “proceed” button and continue the call for connection via the AWS 24, and otherwise the user can activate an “abort call” button to abort the call to be connected.

In one implementation, the caller and called parties register with the AWS 24. At 302 in FIG. 3, a prospective called party Bob with user equipment 202 in FIG. 2 (e.g., a person who obtains a web page on a dating or social networking site via application 10 or 12 in FIG. 1) registers with the AWS 24 and having provided a number or URL to his user equipment 202 as part of the registration. Once Bob's web page is established and presented on the website, another user, such as prospective calling party Alice with user equipment 201 in FIG. 2 accesses the website at 304 in FIG. 3. In one embodiment, upon first visiting the site (or upon initiating an anonymous web call), the prospective caller registers with the AWS 24 at 306, in which process the caller enters their real name, a prepaid or postpaid account associated with the application provider (or a credit card number to be changed for anonymous web calling), as well as a web name for use in making anonymous web calls, and this information is stored by the AWS 24.

The prospective caller Alice then visits the web page of a prospective called party (Bob) at 308. While visiting Bob's web page, the AWS 24 presents Alice with the opportunity to place an anonymous web call to Bob at 310, such as by a clickable button appropriately labeled on the web page by the application 10, 12. Such an actuatable user interface indicia or other means generated by the AWS 24 (e.g., audio prompting for an audio response, etc.) provides a prompt to the prospective calling party Alice to initiate an anonymous web call to a specified called party (in this case Bob) via the web application 10, 12. A determination is made at 312 as to whether the visitor has selected to initiate a call.

The diagram 200 of FIG. 2 shows the calling party UE 201 initiating a web call by accepting the prompt, and the application 10, 12 invokes the AWS 24 via selection messaging 210 to the AWS 24 indicating a desire to initiate the anonymous web call (YES at 312 in FIG. 3). The AWS invokes the Anonymous Web Calling function by sending a call initiation message of the appropriate protocol to the terminating called party 202. In one embodiment, the AWS 24 sends a SIP INVITE message 220 (FIG. 2) to the called party user equipment 202 which was previously registered to the web application 10, 12, and receives a SIP 200 OK message 222. Based at least in part on this reply message 222, the AWS 24 constructs a query message 230. In certain embodiments, the AWS 24 sends the SIP INVITE message 220 to a serving call session control function (CSCF) 32 in an IMS network system 2 identified by current location information stored in the HSS 34 based on the address or number of the called party UE 202.

At 314 (FIG. 3), the AWS 24 queries the charging server 36 (sends the query messaging 230 to the charging server 36 in FIG. 2) for a tariff rate associated with the prospective anonymous web call. The charging server 36 uses the query contents to ascertain the location and call routing information necessary to connect a call from the AWS 24 to the called party UE 202 (called party leg) and also the location and routing information for connecting the call from the calling party US 201 to the AWS 24, and determines a tariff rate (e.g., cents per minute, etc.) based on the location and connection status. The query 230 in certain embodiments can include the address of the AWS 24, an address or number of the calling and called party's user equipment 201, 202, the time of the call, type of quality of service (QOS) and service type information (e.g., voice, data).

The charging server 36 sends a response 232 (FIG. 2) to the AWS 24, which receives the tariff rate at 316 (FIG. 3). At 318, the AWS 24 renders the tariff rate to the calling party 201 (240 in FIG. 2) and prompts the caller at 320 to confirm or refuse initiation of the anonymous web call to the specified called party 202 via the application 10, 12. In certain embodiments, the AWS 24 provides the tariff rate to the application 10, 12, which then presents a pop up window at the calling party user's device 201. The window will show the tariff rate info to be charged for the prospective call. The window will also display 2 buttons “proceed” and “abort call” for user choosing to precede the call if the tariff rate is ok with the user, or abort the call if the tariff rate is not acceptable to the user. If the AWS 24 receives a confirmation via the application 10, 12 of the anonymous web call (confirmation 242 in FIG. 2) from the calling party 201 (YES at 320 in FIG. 3), the call is connected at 322 by the AWS 24 (call 250 in FIG. 2). In connecting the call, the AWS 24 uses the web name provided by the calling party 201 to the web application 10, 12, such that caller ID functions at the called party equipment 202 will not indicate the caller's true identity. When the caller 201 finishes the call, the caller's prepaid/postpaid account or credit card will be charged accordingly. If instead a negative response is received (NO at 320), the AWS aborts the call, and the process returns to 310 as described above.

The CA-AWC (Charging Advice for Anonymous Web Calling) service in certain embodiments is part of the Application Enabler (AE) and the Application Exposure Suite (AES) 24. In certain embodiments, the AWS 24 connects the calling party US 201 with the terminating called party US 202 via an IMS network, or may apply connection techniques appropriate to other technology networks.

Although the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A method for processing anonymous web calls, the method comprising:
using an application web server, prompting a calling party to initiate an anonymous web call to a specified called party via a web application;
using the application web server, receiving a selection indication from the calling party indicating a desire to initiate the anonymous web call to the specified called party;
using the application web server, querying a charging server or a tariff rate associated with the anonymous web call to the called party;
using the application web server, receiving the tariff rate associated with the anonymous web call to the called party from the charging server;
using the application web server, rendering the tariff rate to the calling party and prompting the calling party to confirm initiation of the anonymous web call to the specified called party via the web application;
using the application web server, receiving a confirmation of the anonymous web call from the calling party via the web application; and
using the application web server, connecting the anonymous web call.

2. The method of claim 1, further comprising after receiving the selection indication from the calling party and prior to querying the charging server:
using the application web server, sending a SIP INVITE message to a called party user equipment registered to the web application;
using the application web server, receiving a SIP 200 OK message; and
using the application web server, constructing a query message based at least partially on the SIP 200 OK message.

3. The method of claim 2, further comprising:
using the application web server, after prompting the calling party to confirm initiation of the anonymous web call, receiving negative response from the calling party regarding the anonymous web call via the web application; and
using the application web server, aborting the anonymous web call.

4. The method of claim 2, further comprising:
using the application web server, registering the calling party with the application web server including obtaining a phone number for user equipment of the calling party and a web name to be used in anonymous web calls initiated by the calling party; and
using the web name in connecting the anonymous web call.

5. The method of claim 4, where registering the calling party with the application web server includes obtaining one of a prepaid or postpaid account established by the calling party with a service provider associated with the web application and a credit card account number of the calling party; further comprising using the application web server, charging the prepaid or postpaid account established by the calling party or the credit card account number of the calling party according to the tariff rate after the anonymous web call is completed.

6. The method of claim 2, further comprising:
using the application web server, registering the calling party with the application web server including obtaining one of a prepaid or postpaid account established by the calling party with a service provider associated with the web application and a credit card account number of the calling party; and
using the application web server, charging the prepaid or postpaid account established by the calling party or the credit card account number of the calling party according to the tariff ate after the anonymous web call is completed.

7. The method of claim 1, further comprising:
using the application web server, after prompting the calling party to confirm initiation of the anonymous web call, receiving negative response from the calling party regarding the anonymous web call via the web application; and
using the application web server, aborting the anonymous web call.

8. The method of claim 1, further comprising:
using the application web server, registering the calling party with the application web server including obtaining a phone number for user equipment of the calling party and a web name to be used in anonymous web calls initiated by the calling party; and
using the web name in connecting the anonymous web call.

9. The method of claim 1, where registering the calling party with the application web server includes obtaining one of a prepaid or postpaid account established by the calling party with a service provider associated with the web application and a credit card account number of the calling party; further comprising using the application web server, charging the prepaid or postpaid account established by the calling party or the credit card account number of the calling party according to the tariff rate after the anonymous web call is completed.

10. The method of claim 1, further comprising:
using the application web server, registering the calling party with the application web server including obtaining one of a prepaid or postpaid account established by the calling party with a service provider associated with the web application and a credit card account number of the calling party; and
using the application web server, charging the prepaid or postpaid account established by the calling party or the credit card account number of the calling party according to the tariff rate after the anonymous web call is completed.

11. An application web server, comprising:
a processor programmed to prompt a calling party to initiate an anonymous web call to a specified called party via a web application;
the processor being programmed to receive a selection indication from the calling party indicating a desire to initiate the anonymous web call to the specified called party;
the processor being programmed to query a charging server or a tariff rate associated with the anonymous web call to the called party;
the processor being programmed to receive the tariff rate associated with the anonymous web call to the called party from the charging server;
the processor being programmed to render the tariff rate to the calling party and to prompt the calling party to confirm initiation of the anonymous web call to the specified called party via the web application;
the processor being programmed to receive a confirmation of the anonymous web call from the calling party via the web application; and
the processor being programmed to connect the anonymous web call.

12. The application web server of claim 11, where the processor is further programmed, after receiving the selection indication from the calling party and prior to querying the charging server, to:
send a SIP INVITE message to a called party user equipment registered to the web application;
receive a SIP 200 OK message; and
construct a query message based at least partially on the SIP 200 OK message.

13. The application web server of claim 12, where the processor is programmed to abort the anonymous call if a negative response is received after prompting the calling party to confirm initiation of the anonymous web call.

14. The application web server of claim 12, where the processor is programmed to register the calling party with the application web server including obtaining a phone number for user equipment of the calling party and a web name to be used in anonymous web calls initiated by the calling party, and where the processor is programmed to use the web name in connecting the anonymous web call.

15. The application web server of claim 14, where the processor is programmed to obtain one of a prepaid or postpaid account established by the calling party with a service provider associated with the web application and a credit card account number of the calling party, and where the processor is programmed to charge the prepaid or postpaid account established by the calling party or the credit card account number of the calling party according to the tariff rate after the anonymous web call is completed.

16. The application web server of claim 12, where the processor is programmed to obtain from the calling party one of a prepaid or postpaid account established by the calling party with a service provider associated with the web application and a credit card account number of the calling party, and where the processor is programmed to charge the prepaid or postpaid account established by the calling party or the credit card account number of the calling party according to the tariff rate after the anonymous web call is completed.

17. The application web server of claim 11, where the processor is programmed to abort the anonymous call if a negative response is received after prompting the calling party to confirm initiation of the anonymous web call.

18. The application web server of claim 11, where the processor is programmed to register the calling party with the application web server including obtaining a phone number for user equipment of the calling party and a web name to be used in anonymous web calls initiated by the calling party, and where the processor is programmed to use the web name in connecting the anonymous web call.

19. The application web server of claim 18, where the processor is programmed to obtain one of a prepaid or postpaid account established by the calling party with a service provider associated with the web application and a credit card account number of the calling party, and where the processor is programmed to charge the prepaid or postpaid account established by the calling party or the credit card account number of the calling party according to the tariff rate after the anonymous web call is completed.

20. The application web server of claim 11, where the processor is programmed to obtain from the calling party one of a prepaid or postpaid account established by the calling party with a service provider associated with the web application and a credit card account number of the calling party, and where the processor is programmed to charge the prepaid or postpaid account established by the calling party or the credit card account number of the calling party according to the tariff rate after the anonymous web call is completed.
